(19) United States
(12) Patent Application Publication
(10) Pub. No.: US 2004/0239180 A1
(43) Pub. Date: Dec. 2, 2004

(54) Antilock electro-hydraulic hybrid brake system and method

(75) Inventor: Jeff A. Foust, Eaton, OH (US)

Correspondence Address: SCOTT A. MCBAIN, DELPHI TECHNOLOGIES, INC., Legal Staff, Mail Code: 480-410-202, P.O. BOX 5052, Troy, MI, 48007, US

(73) Assignee: DELPHI TECHNOLOGIES INC.

(21) Appl. No.: 10/445,583

(22) Filed: May 27, 2003

(51) Int. Cl. B60T 8/64

(52) U.S. Cl. 303/152

(57) ABSTRACT

For a motor vehicle, a brake system, an antilock electro-hydraulic hybrid brake system, and a method of braking. The brake system includes at least one first wheel assembly including a non-antilock brake apparatus with a first actuator, and at least one wheel assembly including an antilock brake apparatus with a second actuator. A received brake signal activates at least one of the first and second actuators to provide a braking force for the vehicle. A front wheel set may include the first wheel assembly with the first actuator being hydraulic. A rear wheel set may include the second wheel assembly with the second actuator being electric. The method includes receiving a brake signal, applying a non-antilock brake force to at least one wheel assembly based on the received brake signal, and applying an antilock brake force to at least one wheel assembly based on the received brake signal.

### TECHNICAL FIELD OF THE INVENTION

The present invention relates generally to the field of vehicular brake systems. More particularly, the invention relates to an antilock electro-hydraulic hybrid brake system and method.

### BACKGROUND OF THE INVENTION

Virtually all motorized vehicles utilize braking systems to selectively inhibit wheel rotation and, therefore, reduce vehicle speed. Braking may be accomplished by the use of hydraulic, electronic, or hybrid electro-hydraulic means whereby a friction force is applied at one or more wheel assemblies to inhibit wheel rotation. Numerous brake systems are known in the art. Such systems generally include a rotor or disc secured to the vehicle wheel, a caliper assembly mounted to the vehicle chassis, and a pair of friction pads disposed on opposing sides of the rotor. Upon activation of the brake system, the caliper moves the friction pads toward one another into frictional engagement with the rotor actuating braking force and slowing the vehicle. When the brake is released, the caliper moves the friction pads out of frictional engagement with the rotor allowing free tire rotation.

Antilock braking systems (ABS) are becoming more common on vehicles, particularly automobiles and light trucks. When the driver applies the brakes, the ABS monitors whether a tire is skidding or about to skid, and automatically releases the brakes for a short period, so the wheel is allowed to rotate, rather than skid. The ABS control system manages braking pressure in either an applied, hold, or release state, cycling from one to the other throughout the stop, depending on a wheel's skid condition.

Hydraulic brake system typically include a plurality of fluid pressure actuated wheel brakes, a master cylinder, and a brake pedal linked to a piston assembly in the master cylinder. To apply the wheel brakes, a vehicle operator pushes on the brake pedal and linearly strokes the piston assembly to create a high fluid pressure in the wheel brakes through a plurality of hydraulic channels. Before the wheel brakes become applied, fluid expelled by the piston assembly must first take up compliance in the wheel brakes and in the hydraulic channels. To maximize response, the piston assembly typically has a relatively large effective area in order to rapidly expel a substantial volume of fluid at relatively low fluid pressure at the onset of pedal travel. To attain high fluid pressure to apply the wheel brakes without requiring that the operator apply an uncomfortably high pedal force, the hydraulic motor vehicle brake system also typically includes a booster which supplements the pedal force applied by the operator.

An electronic brake system, commonly known as brake-by-wire, is distinguished from the hydraulic brake systems by the elimination of hydraulic lines linking the master cylinder to the brake actuators with one or more electronic connections (e.g., wires, radio frequency coupling, etc.). The wheel brakes may be applied by electro-hydraulic or electromechanical actuators. The brake actuators typically include a piston that performs the function of the master cylinder piston assembly but is driven through a speed reducer by an electric motor under the control of an electronic control unit (ECU) on the motor vehicle.

Traditionally, ABS have been electro-hydraulic systems, that is, a hybrid system combining brake-by-wire and hydraulic components. The ABS have been constructed as full four-wheel—four-channel ABS, four-wheel—three-channel ABS (rear wheel common), or a generally less expensive one-channel rear wheel unlocking system. Each of these braking systems may require a relatively expensive hydraulic modulator to implement the ABS function. However, recent developments in vehicle braking systems employing a full brake-by-wire setup have eliminated the need for the hydraulic modulator.

Systems based on this electronic brake technology may be built as a full four-corner electric brake system or a front hydraulic with a rear electric hybrid vehicle brake system. Consequently, the need for the hydraulic modulator has been completely eliminated by the full four-wheel electric brake system, but this system may be expensive and require modifications to the standard vehicle electrical system to meet the safety and redundancy requirements placed on today's brake systems. However, the need for a front hydraulic modulator is still required for the four-wheel ABS using a hybrid vehicle brake system. Accordingly, it would be desirable to provide a relatively inexpensive ABS that eliminates the need for a hydraulic modulator.

Therefore, it would be desirable to provide an antilock electro-hydraulic hybrid braking system and method that would overcome the aforementioned and other disadvantages.

### SUMMARY OF THE INVENTION

A first aspect of the present invention provides a brake system for a motor vehicle. The brake system includes at least one wheel assembly including a non-antilock brake apparatus with a first actuator, and at least one wheel assembly including an antilock brake apparatus with a second actuator. A received brake signal activates at least one of the first and second actuators to provide a braking force for the vehicle.

A second aspect of the invention provides an antilock electro-hydraulic hybrid brake system for a motor vehicle. The hybrid brake system includes front and rear wheel sets each including at least one wheel assembly. The front wheel assembly includes a non-antilocking brake apparatus with a hydraulic actuator. The rear wheel assembly includes an antilock brake apparatus with an electric actuator. The received brake signal activates the hydraulic actuator and the electric actuator to provide a braking force for the vehicle.

A third aspect of the invention provides a method of braking a motor vehicle. The method includes receiving a brake signal, applying a non-antilock brake force to at least one wheel assembly based on the received brake signal, and applying an antilock brake force to at least one wheel assembly based on the received brake signal.

A fourth aspect of the invention provides a computer usable medium including a program for braking a motor vehicle. The computer usable medium includes computer usable program code for receiving a brake signal, computer usable program code for applying a non-antilocking brake force to at least one wheel assembly in proportion to the brake signal, and computer usable program code for applying an antilocking brake force to at least one wheel assembly in proportion to the brake signal.

The foregoing and other features and advantages of the invention will become further apparent from the following detailed description of the presently preferred embodiments, read in conjunction with the accompanying drawings. The detailed description and drawings are merely illustrative of the invention, rather than limiting the scope of the invention being defined by the appended claims and equivalents thereof.

### BRIEF DESCRIPTION OF THE DRAWINGS

FIG. 1 is a schematic view of a vehicle with an antilock electro-hydraulic hybrid brake system in accordance with one embodiment of the present invention;

FIG. 2 is a schematic view of a vehicle with an antilock electro-hydraulic hybrid brake system in accordance with another embodiment of the present invention; and

FIG. 3 is a flow diagram of a motor vehicle braking algorithm for use in the electronic control unit (ECU) of FIG. 1, in accordance with the present invention.

### DESCRIPTION OF THE PRESENTLY PREFERRED EMBODIMENT

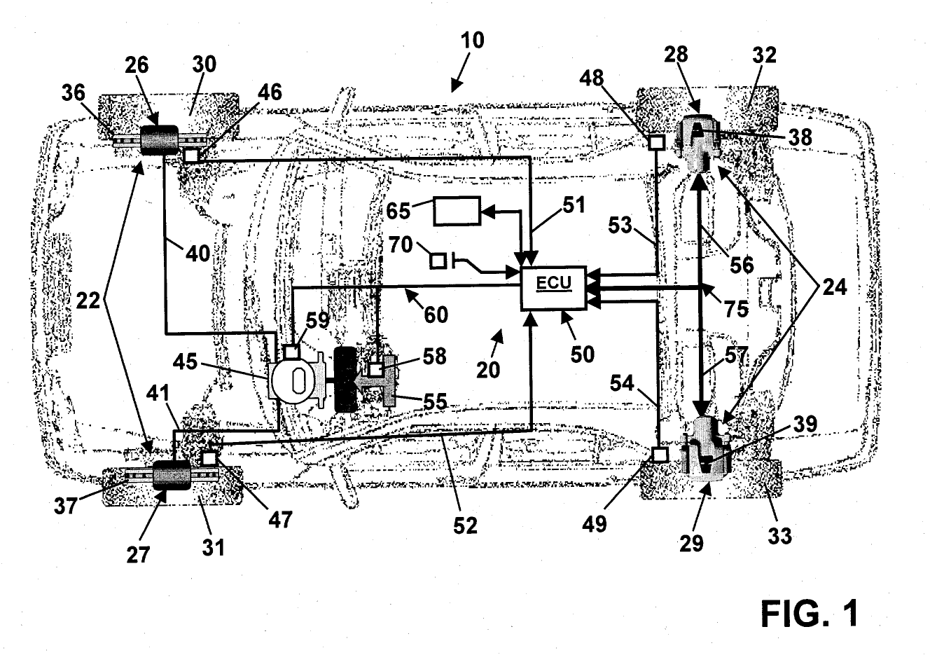

Referring to the drawings, wherein like reference numerals refer to like elements, FIG. 1 is a schematic view of a motor vehicle, shown generally by numeral 10, with an antilock electro-hydraulic hybrid brake system 20 in accordance with the present invention. Those skilled in the art will recognize that the vehicle 10 and brake system 20 may include a number of alternative designs and may be employed in a variety of applications. In the present description and figures, the vehicle 10 and brake system 20 include a non-antilock front wheel set 22 and an antilock rear wheel set 24, each wheel set 22, 24 including two wheel assemblies 26, 27, 28, 29. The configuration, number, and design of the vehicle 10, brake system 20, and wheel sets 22, 24 may vary while providing an effective hybrid antilock braking strategy. The present description and figures are provided merely as a working example of a motor vehicle with an antilock electro-hydraulic hybrid brake system in accordance with the present invention.

Vehicle 10 wheel assemblies 26, 27, 28, 29 may each include wheels 30, 31, 32, 33 coupled to a suspension (not shown), which may include dampers, struts, springs, or other dampening means. For example, each suspension may include a variable-force, real time, controllable MR damper connected to dampen vertical forces between the wheel 30, 31, 32, 33 and vehicle 10 body at that suspension point. Although many such suspension arrangements are known and may be adapted for use with the present invention, the suspension may be an electrically controllable, variable dampening force shock absorber with a weight bearing coil spring in a parallel spring/shock absorber, a McPherson strut arrangement, or any other suitable suspension arrangement.

Wheel assemblies 26, 27, 28, 29 may each include braking means, such as a conventional disc brake system 36, 37, 38, 39. The brake systems 36, 37, 38, 39 may each include a disc brake and a hub, which provides a mounting for the wheels 30, 31, 32, 33. The hub may be mounted (e.g., on a suspension link of a vehicle) for rotation about a central axis of the hub. The disc brake may include a disc which is fixedly mounted on the hub for rotation therewith. The brake systems 36, 37, 38, 39 may also include friction material pads arranged on opposite sides of the disc, and a piston and cylinder assembly operable to urge the pads into engagement with the disc, to brake the hub and hence the wheels 30, 31, 32, 33. Conventionally, the piston and cylinder assembly is slidably mounted and a caliper bridging an edge of the disc is fixed to a cylinder of the assembly. One friction pad may be acted on directly by the piston and cylinder assembjy while the other pad is mounted on the caliper on the opposite side of the disc.

Hydraulic lines 40, 41 including a pressurized hydraulic fluid may be provided between a brake master cylinder 45 and the wheel assemblies 26, 27 to actuate the brake systems 36, 37. Brake systems 36, 37 provide a non-antilock brake arrangement and therefore do not require a hydraulic modulator. As such, the overall cost and complexity of the brake system 20 may be reduced. Brake systems 38, 39 may be coupled to an electronic control unit 50 (ECU) by a variety of means known in the art, such as a radio frequency transmission or by coupled wire to actuate braking. Brake systems 38, 39 preferably provide antilock braking and, optionally, other advanced braking functions.

Operation of the brake systems 36, 37, 38, 39 may involve pressing of the friction pads against the disc thereby causing sliding movement of the cylinder of the assembly and of the caliper to bring another pad into engagement with the disc. As such, a braking force is applied to the disc and hence to the hub, which serves to effectively brake the vehicle 10. Increased hydraulic fluid pressure in the hydraulic lines 40, 41 may be used to manually actuate braking in the wheel assemblies 26, 27 whereas electro-motors may be used to automatically actuate braking in the wheel assemblies 28, 29. Those skilled in the art will recognize that numerous other brake system types and arrangements may be adapted for use with the present invention. For example, the vehicle 10 may include drum brakes, other disc brake system arrangements, and/or a variety of (electro-)hydraulic and (electro-)mechanical brake actuators.

Each wheel assembly 26, 27, 28, 29 may include a wheel speed sensor 46, 47, 48, 49 that provides an output signal, represented by line 51, 52, 53, 54 indicative of the rotational speed of the corresponding wheel 30, 31, 32, 33 at that corner of the vehicle 10. Each wheel speed sensor 46, 47, 48, 49 may further include an internal circuit board with a buffer circuit for buffering the output signal, which may be provided to the ECU 50. Output signals 51, 52, 53, 54 may be relayed to the ECU 50 by a variety of means known in the art, such as a radio frequency transmission or by coupled wire. Suitable wheel speed sensors 46, 47, 48, 49 are known to, or can be constructed by, those skilled in the art. Numerous alternative types of speed, velocity, and acceleration type sensors, including transformer type sensors, may be adapted for use with the present invention.

In one embodiment, the ECU 50 may include a digital microprocessor programmed to process a plurality of input signals with a stored algorithm, and to generate output control signals 56, 57 for providing antilock braking control of the rear wheel set 24. The methods, algorithms, and determinations (e.g., calculations and estimations), including those based on equations or value tables, may be performed by a device such as the ECU 50. ECU 50 may receive input, perform determinations, and provide output for controlling the antilock braking characteristics of the rear wheel set 24 and/or other vehicle 10 functions. A vehicle interface 65 and a parking brake switch 70 may be operably coupled to the ECU 50. In one embodiment, the vehicle interface 65 may provide communication between the ECU 50 and other systems (e.g., engine, suspension, etc.) in the vehicle 10 as well as electric power for the brake system 20. The parking brake switch 70 may provide a signal to the ECU 50 and the rear wheel set 24 thereby activating the brakes while the vehicle 10 is in a parked mode of operation. An electrical bus 75 may operably couple the ECU 50 and wheel assemblies 28, 29 of the rear wheel set 24.

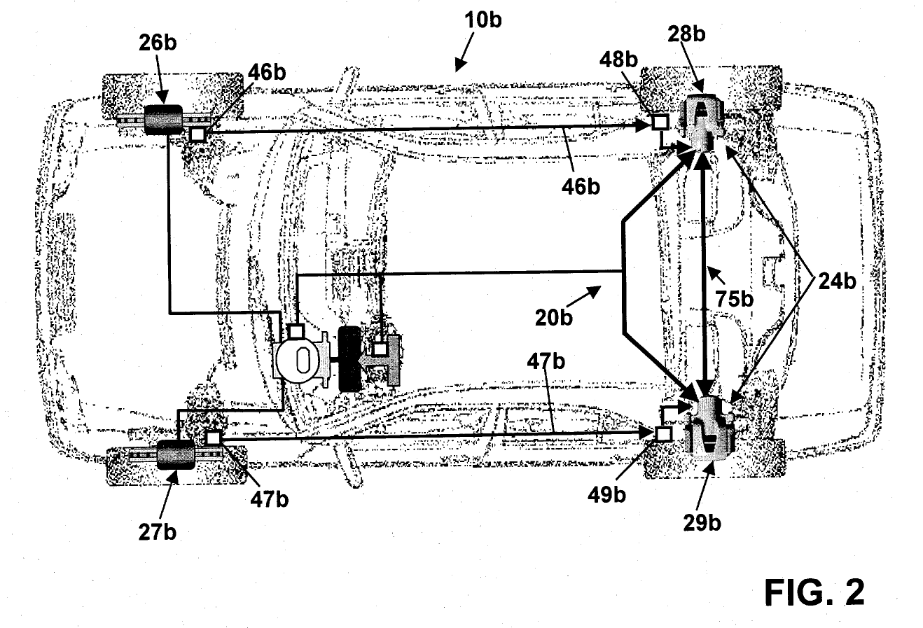

In another embodiment, as shown in vehicle 10b brake system 20b of FIG. 2, the function of the ECU may be performed by one or more analogous devices integrated into wheel assemblies 28b, 29b thereby providing more compact “packaging” and eliminating the need for a separate ECU. Information from wheel speed sensors 46b, 47b may be relayed from wheel assemblies 26b, 27b to wheel assemblies 28b, 29b along with information from wheel speed sensors 48b, 49b, respectively. Electrical bus 75b may directly couple wheel assemblies 28b, 29b of rear wheel set 24b to each other.

Referring again to FIG. 1, the computer usable medium and value tables associated with the present invention may be programmed or read into a microprocessor memory portion (e.g., ROM, RAM, and the like) for executing functions associated with the present invention. Analog signal processing may be provided for some of the input signals. For example, the signals from the wheel speed sensors 46, 47, 48, 49 may be low-pass filtered through four analog low-pass filters and differentiated through four analog differentiators to provide four discrete relative speed signals, one for each wheel 30, 31, 32, 33.

Various other digital/discrete and/or analog/continuous signals may be provided to the ECU 50 through an I/O apparatus. In one embodiment, one or more sensors 58, 59 may sense the position or status of a brake pedal 55 thereby generating a corresponding output signal 60 to the ECU 50. In one embodiment, sensor 58 may be operably coupled to the brake pedal 55 and sensor 59 may be operably coupled to the brake master cylinder 45 thereby providing sensor redundancy. The signals 51, 52, 53, 54, 60 may be buffered in a manner known in the art to remove unwanted noise. Furthermore, the signals 51, 52, 53, 54, 60 may comprise a pulse train having pulse timing, of which the type and decoding are well known in the art. Those skilled in the art will recognize that the ECU 50 may receive other input signal(s) and generate other output signal(s) for providing an effective antilock braking strategy in accordance with the present invention.

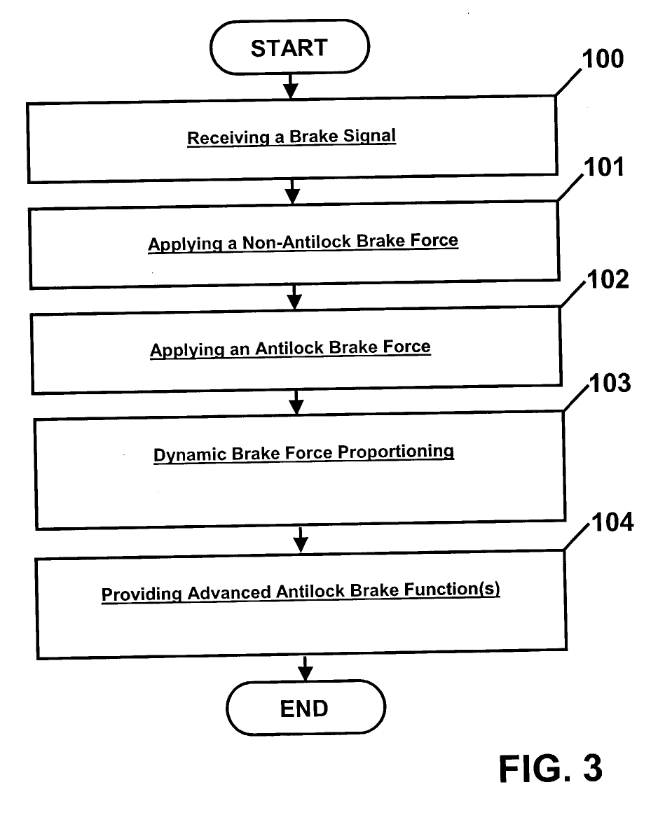

FIG. 3 is a flow diagram of a motor vehicle braking algorithm for use in the ECU 50 of FIG. 1. In one embodiment, the algorithm may begin by receiving a brake signal (step 100). The ECU 50 may receive the brake signal 60 from the brake pedal 55, the master cylinder 45, or both. The signal 60 “intensity” is typically in proportion to a brake pedal force from one or more sensors as known in the art. The sensors may be one or more position sensors, force sensors, and the like.

A non-antilock brake force is applied to at least one wheel assembly based on the received brake signal (step 101). In one embodiment, the non-antilock brake force may be applied to the front wheel set 22 wherein the disc brake systems 36, 37 are hydraulically activated as known in the art. In another embodiment, the non-antilock brake force may be applied to the rear wheel set or another wheel set through hydraulic activation or other means.

An antilock brake force is also applied to at least one wheel assembly based on the received brake signal (step 102). In one embodiment, the antilock brake force may be applied to the rear wheel set 24 wherein the brake systems 38, 39 are electronically activated as known in the art. As the antilock brake force is applied through electronic means, the need for a hydraulic modulator is eliminated, potentially reducing the cost and complexity of the brake system 20. The wheel speed thresholds for determining antilock brake activation may be programmed as one or more equations and/or value tables in the ECU 50 microprocessor memory portions. The thresholds may vary by vehicle and driving condition. In another embodiment, the antilock brake force may be applied to the front wheel set or another wheel set through electronic activation or other means.

Several advantages of the antilock electro-hydraulic hybrid brake system 20 relate to a capability to continuously assess the mode of vehicle 10 operation through the ECU 50 and to applying an appropriate brake response with varying condition and situations. ECU 50 may include a dynamic rear proportioning capability that monitors wheel 30, 31, 32, 33 speeds and adjust the front and rear braking forces appropriately with respect to one another (step 103). This may increase brake system 20 efficiency and reduce brake pad wear.

Brake system 20 may also include one or more advanced brake functions programmed into the ECU 50 (step 104). One advanced brake function of the ECU 50 may include a hill holding function. For example, the rear wheel set 24 brake systems 38, 39 may be lightly applied while the vehicle 10 is stopped on a hill to ensure the vehicle 10 is held in a stationary position until the engine torque exceeds the gravitational force. When the engine torque does exceed the gravitational force, the brake systems 38, 39 release and the vehicle 10 may continue in the intended direction.

Another advanced brake function includes vehicle stability enhancement (VSE) function. For example, the ECU 50 may continuously monitor the vehicle 20 speed and steering angle(s) adjusting the braking force of each corner or side of the vehicle 10. As such, the brake systems 38, 39 may be applied in appropriate situations to assist in the stability and steering of the vehicle 10.

Yet another advanced brake function includes a traction control function for rear wheel drive vehicles. Using input from the wheel speed sensors 46, 47, 48, 49 and information relating to engine torque, the ECU 50 may determine a traction control event wherein rear wheel 28, 29 slip is detected during vehicle 10 acceleration. In such a situation, the ECU 50 may apply one or both of the rear wheel brake systems 38, 39. The ECU 50 may then send an output signal to limit engine torque during an extended traction control event.

While the embodiments of the invention disclosed herein are presently considered to be preferred, various changes and modifications may be made without departing from the spirit and scope of the invention. The brake system and vehicle configuration, method, and computer usable medium may vary while providing an antilock braking strategy in accordance with the present invention. For example, the vehicle, brake systems, and wheel assemblies, may include various changes, configurations, arrangements, and the like that may vary without limiting the utility and practice of the present invention. Furthermore, the method may be accomplished by numerous alternative strategies, may include additional steps, and vary in step order.

Upon reading the specification and reviewing the drawings hereof, it will become immediately obvious to those skilled in the art that myriad other embodiments of the present invention are possible, and that such embodiments are contemplated and fall within the scope of the presently claimed invention. The scope of the invention is indicated in the appended claims, and all changes that come within the meaning and range of equivalents are intended to be embraced therein.

1. A brake system for a motor vehicle, the brake system comprising:
at least one wheel assembly comprising a non-antilock brake apparatus including a first actuator; and
at least one wheel assembly comprising an antilock brake apparatus including a second actuator;
wherein a received brake signal activates at least one of the first and second actuators to provide a braking force for the vehicle.

2. The system of claim 1 wherein the first actuator comprises a hydraulic actuator.

3. The system of claim 1 wherein the second actuator comprises an electric or an electro-hydraulic actuator.

4. The system of claim 1 wherein the wheel assembly comprising the non-antilock brake apparatus comprises a front wheel assembly.

5. The system of claim 1 wherein the wheel assembly comprising the antilock brake apparatus comprises a rear wheel assembly.

6. The system of claim 1 further comprising an electronic control unit for modulating an antilock brake function, the electronic control unit operably attached to the wheel assembly comprising the antilock brake apparatus.

7. The system of claim 1 wherein the electronic control unit provides at least one advanced brake function.

8. An antilock electro-hydraulic hybrid brake system for a motor vehicle, the brake system comprising:
a front wheel set including at least one wheel assembly, said wheel assembly comprising a non-antilocking brake apparatus including a hydraulic actuator; and
a rear wheel set including at least one wheel assembly, said wheel assembly comprising an antilock brake apparatus including an electric actuator;
wherein a received brake signal activates the hydraulic actuator and the electric actuator to provide a braking force for the vehicle.

9. The system of claim 8 further comprising an electronic control unit for modulating an antilock brake function, the electronic control unit operably attached to the wheel assembly comprising the antilock brake apparatus.

10. The system of claim 8 wherein the electronic control unit provides at least one advanced brake function.

11. A method of braking a motor vehicle, the method comprising:
receiving a brake signal;
applying a non-antilock brake force to at least one wheel assembly based on the received brake signal; and
applying an antilock brake force to at least one wheel assembly based on the received brake signal.

12. The method of claim 11 wherein receiving the brake signal comprises receiving a brake pedal input and a master cylinder input.

13. The method of claim 11 wherein the non-antilock brake force is applied to at least one front wheel assembly.

14. The method of claim 11 wherein the antilock brake force is applied to at least one rear wheel assembly.

15. The method of claim 11 further comprising proportioning the applied non-antilock and antilock brake forces.

16. The method of claim 11 further comprising providing at least one advanced brake function.

17. A computer usable medium including a program for braking a motor vehicle, the computer usable medium comprising:
computer usable program code for receiving a brake signal;
computer usable program code for applying a non-antilocking brake force to at least one wheel assembly in proportion to the brake signal; and
computer usable program code for applying an antilocking brake force to at least one wheel assembly in proportion to the brake signal.

18. The method of claim 17 further comprising computer usable program code for proportioning the applied non-antilock and antilock brake forces.

19. The method of claim 17 further comprising computer usable program code for providing at least one advanced brake function.
